(19) United States
(12) Patent Application Publication
(10) Pub. No.: US 2003/0132143 A1
(43) Pub. Date: Jul. 17, 2003

(54) SORTATION SYSTEM MAGNETIC DIVERTER

(76) Inventors: Gary D. Cochran, Ann Arbor, MI (US); Clyde M. Ko, Ada, MI (US); David W. Zeitler, Caledonia, MI (US); Frank W. Veit, Spring Lake, MI (US)

(21) Appl. No.: 10/248,235

(22) Filed: Dec. 30, 2002

Related U.S. Application Data
(60) Provisional application No. 60/347,552, filed on Jan. 11, 2002.
(60) Provisional application No. 60/372,716, filed on Apr. 15, 2002.

(51) Int. Cl. B07C 9/00

(52) U.S. Cl. 209/653; 209/657; 209/916; 198/737

(57) ABSTRACT

### Abstract of Disclosure

A method and apparatus for sorting objects includes providing a sorter having a conveying surface, a plurality of pusher shoes capable of traveling laterally of the conveying surface, a plurality of diverting rails extending diagonally under the conveying surface, and a plurality of diverters associated with the diverting rails. The pusher shoes including an article-contacting member extending at least partially above the conveying surface to laterally displace articles on the conveying surface and a transfer assembly having a magnetic member below the conveying surface. The transfer assembly engages ones of the diverting rails to laterally displace the corresponding one of the pusher shoes. Actuators are provided at the diverters. The actuators are selectively energized to attract at least one of the magnetic members towards the associated one of the diverting rails. Residual magnetic attraction between the actuators and the magnetic members is reduced when the actuators are not being energized.

### Cross Reference to Related Applications

This application claims priority from United States provisional patent application Serial No. 60/347,552 filed on January 11, 2002, and United States provisional patent application Serial No. 60/372,716 filed on April 15, 2002, the disclosures of which are hereby incorporated herein by reference in their entireties.

### Background of Invention

This invention relates generally to conveyor sortation systems, or sorters, and, in particular, diverters used in such sortation systems. The invention is especially useful with sortation systems having diverters utilizing electromagnetic energy to initiate a divert while the invention may be applied to a sorter that diverts articles without imparting a rotational motion on the article, also known as a parallel sorter; however, the invention is capable of other applications.

Various forms of conveyor sortation systems have been known, such as paddle diverters, pushers, pop-up chain and belt transfer assemblies, and the like. One particular advantageous form of a sortation system is a positive displacement sortation system in which a series of pusher shoes are mounted to travel in the direction of the conveying surface and, when diverted, to travel laterally along the conveying system to divert articles on the conveying surface. For example, articles may be diverted to takeaway conveyors, or spurs, arranged either on one side of the conveying surface, thereby defining a unilateral divert, or on both sides of the conveying surface, thereby defining a bilateral divert. The pusher shoes are propelled laterally by a propelling assembly extending below the conveying surface and selectively engaging a diverter rail which extends diagonally under the conveying surface. Diverters associated with the diverting rail selectively divert the propelling assemblies onto the associated diverting rail in order to cause the pusher shoes to travel laterally of the conveying surface. If a particular pusher shoe is not diverted onto a particular diverting rail, then the shoe continues to travel solely in the direction of the conveying surface unless a downstream diverter diverts the pusher shoe onto its associated diverter rail. An example of such positive displacement sorter includes commonly assigned United States Patent No. 5,127,510. Other examples of positive displacement sorters are disclosed in United States Patent Nos. 3,361,247 and 4,884,677.

One form of a diverter is disclosed in United States Patent No. 5,409,095, the disclosure of which is hereby incorporated herein by reference. The '095 patent discloses a diverter made up of an electromagnet that, when energized, attracts the propelling assembly of the pusher shoe and guides the propelling assembly onto the associated diverting rail. In the embodiment illustrated in the '095 patent, the propelling assembly includes a bearing made of a ferromagnetic, or magnetically permeable, substance, such as iron alloy. The electromagnet, when energized, attracts the bearing thereby diverting the associated pusher shoe onto the diverting rail associated with the diverter. The electromagnetic diverter disclosed in the '095 patent is desirable because it is capable of diverting pusher shoes traveling at a high rate of speed thereby increasing the throughput of articles sorted by the sorter. Additionally, the pusher shoes can be diverted with less noise than is produced with mechanical or electromechanical diverters.

A particularly advantageous form of a sorter is one which, at least initially, diverts articles without rotating the articles. Such a parallel divert sorter is disclosed in commonly assigned United States Patent Nos. 5,165,515; 5,927,465 and 6,041,909 and pending United States patent application Serial No. 09/606,610 filed June 29, 2000, by J. Shearer, J. et al. entitled CONVEYOR SYSTEM WITH DIVERTING TRACK NETWORK, the disclosures of which are hereby incorporated herein by reference. Because the articles are at least initially diverted without rotating the articles, it is possible to include a smaller gap between articles because it is not necessary to leave sufficient gap for rotation of the articles. This also improves the throughput of the sorter. One difficulty of using an electromagnetic diverter with a parallel divert sorter is that it may be necessary to space the diverting rails and diverters as close together as the pitch between the pusher shoes. Because pusher shoe pitch may be as low as 5 or 6 inches, it may be necessary to utilize as low as 5-inch or 6-inch spacing between magnetic diverters. Because of the electromagnetic force necessary to attract the bearing of a pusher shoe in order to divert that pusher shoe onto a diverting rail, the size of the electromagnetic diverter becomes prohibitive for use in a parallel divert sorter of the type disclosed in the '515, '465, and '909 patents and the 09/606,610 pending application. This difficulty was overcome in United States patent application Serial No. 09/840,639 filed April 23, 2001, by Veit et al. for a SORTATION SYSTEM DIVERTER SWITCH. This patent document discloses a diverter switch utilizing transfer assemblies under the pusher shoes, instead of the traditional bearings, and an actuator for selectively diverting the transfer assembly to the diverting rails. The transfer assembly includes a pilot member made of a magnetic material, or magnetically permeable material, on a toggle member that is pivotally mounted on the pusher shoe. Once the divert is initiated magnetically, it is completed mechanically. This reduces the amount of magnetic force needed to attach the relatively low-mass pilot member and, hence, the size of the actuator. However, the low mass of the pilot member creates difficulties that must be overcome to avoid mis-diverts and failed diverts.

### Summary of Invention

A method and apparatus for sorting objects, according to an aspect of the invention, includes providing a sorter having a conveying surface, a plurality of pusher shoes capable of traveling laterally of the conveying surface, a plurality of diverting rails extending diagonally under the conveying surface and a plurality of diverters associated with the diverting rails. The pusher shoes include article-contacting members extending at least partially above the conveying surface to laterally displace articles on the conveying surface and magnetic members below the conveying surface, the magnetic members engaging the diverting rails to laterally displace the pusher shoes. Actuators are provided at the diverters for selectively actuating at least one of the magnetic members towards the associated one of the diverting rails. Residual magnetic attraction between the actuator and the magnetic members is reduced when the actuators are not being energized.

The residual magnetic attraction may be reduced by reducing residual magnetism at the actuators. The actuators may include a primary magnetic coil and produce with the primary magnetic coil a magnetic flux having a particular polarity in order to attract at least one of the magnetic members. Residual magnetism may be reduced by providing an auxiliary magnetic coil and producing with the auxiliary magnetic coil another magnetic flux having a polarity that is opposite to the particular polarity. The magnetic flux that attracts the at least one of the magnetic members may be produced by applying an electric current to the primary magnetic coil and the other magnetic flux may be produced by applying another electric current to the auxiliary magnetic coil. The another electric current may be applied after the electric current is applied. The residual magnetism may be reduced by providing a permanent magnet and producing with the permanent magnet another magnetic flux having a polarity that is opposite to the particular polarity.

The residual magnetic attraction may be reduced by spacing the magnetic members from the actuators. This may be accomplished by providing spacers and positioning the spacers between the magnetic members and the actuators. The spacing may also be accomplished by configuring a face of the actuators that attracts the magnetic members to be laterally offset from a path of longitudinal movement of the magnetic members.

The residual magnetic attraction may also be reduced by providing permanent magnets at the magnetic members and repelling the permanent magnets with the actuators when the actuators are not attracting the magnetic members. This may be accomplished by providing other permanent magnets at the actuators having poles arranged to repel the permanent magnets.

The magnetic members may include a transfer assembly having a pilot member made of a magnetically permeable material, such as a roller. The magnetic member may further include a trailing low-friction member. The conveying surface may be defined by an upper run of a plurality of slats that are interconnected in an endless web and the pusher shoes travel along at least some of the plurality of slats to laterally displace articles on the conveying surface. Corresponding portions of the pusher shoes are generally separated from each other in the direction of travel by a shoe pitch. Corresponding portions of at least two of the actuators may be substantially spaced from each other by no more than the shoe pitch, thereby providing at least partial parallel sorting.

These and other objects, advantages and features of this invention will become apparent upon review of the following specification in conjunction with the drawings.

### Brief Description of Drawings

Fig. 1 is a perspective view of a positive displacement sorter assembly, according to the invention;

Fig. 2 is a perspective view of a diverter assembly useful with the invention;

Fig. 3 is a top plan view of the diverter assembly in Fig. 2;

Fig. 4 is a perspective view of an actuator with the actuating coil winding removed in order to reveal details thereof, according to the invention;

Fig. 5 is a top plan view of the actuator in Fig. 4;

Fig. 6 is a side elevation of the actuator in Fig. 4 taken from the direction VI-VI in Fig. 5;

Fig. 7 is the same view as Fig. 6 showing a spacer, according to an aspect of the invention;

Fig. 8 is the same view as Fig. 7 showing an alternative embodiment thereof;

Fig. 9 is the same view as Fig. 7 showing an alternative embodiment thereof;

Fig. 10 is the same view as Fig. 6 showing a pair of permanent magnets, according to an aspect of the invention;

Fig. 11 is an electrical schematic diagram of a pair of electromagnets, according to an aspect of the invention;

Fig. 12 is the same view as Fig. 3 of an alternative embodiment thereof;

Fig. 13 is a top plan view of the actuator used in the diverter assembly in Fig. 12;

Fig. 14 is the same view as Fig. 13 of an alternative embodiment thereof;

Fig. 15 is an enlarged view that is the same as Fig. 3 of an alternative embodiment thereof; and

Fig. 16 is an electrical schematic diagram of an actuating current generating circuit.

### Description of the Preferred Embodiment

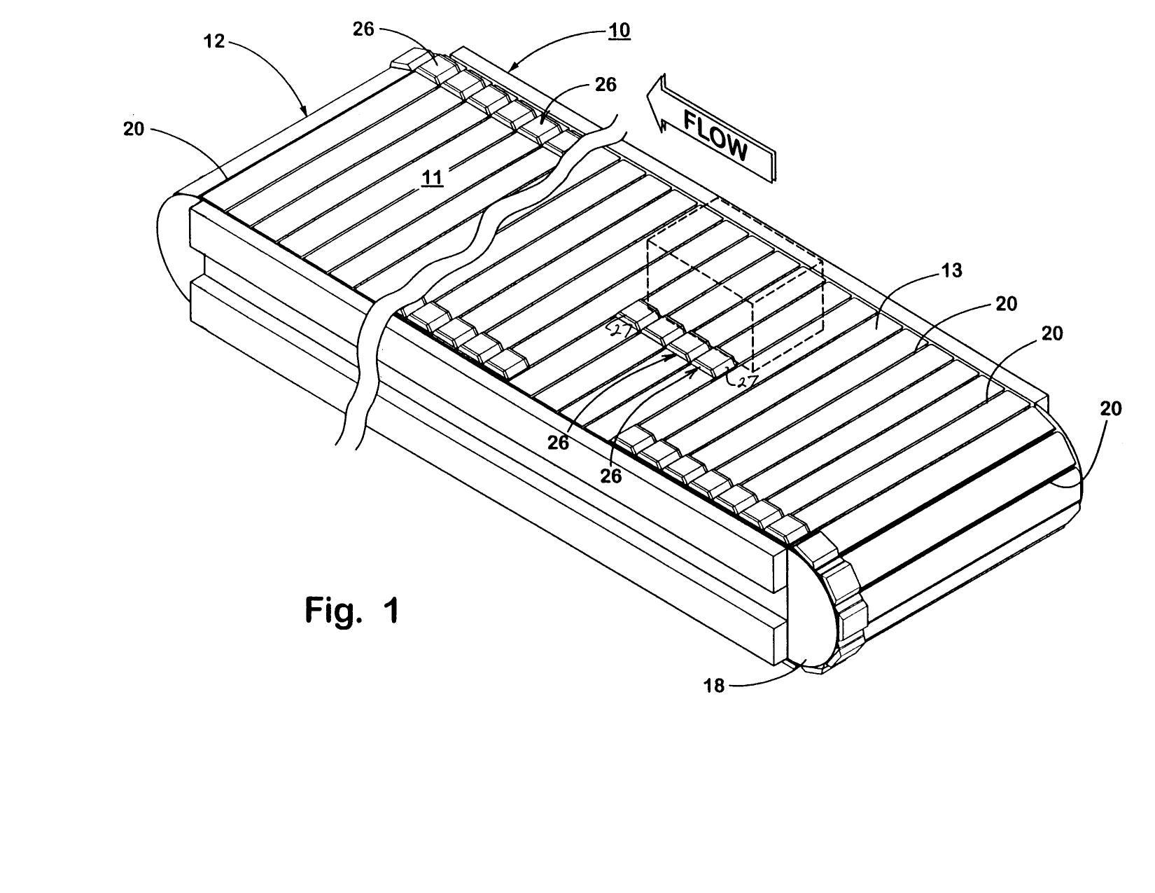

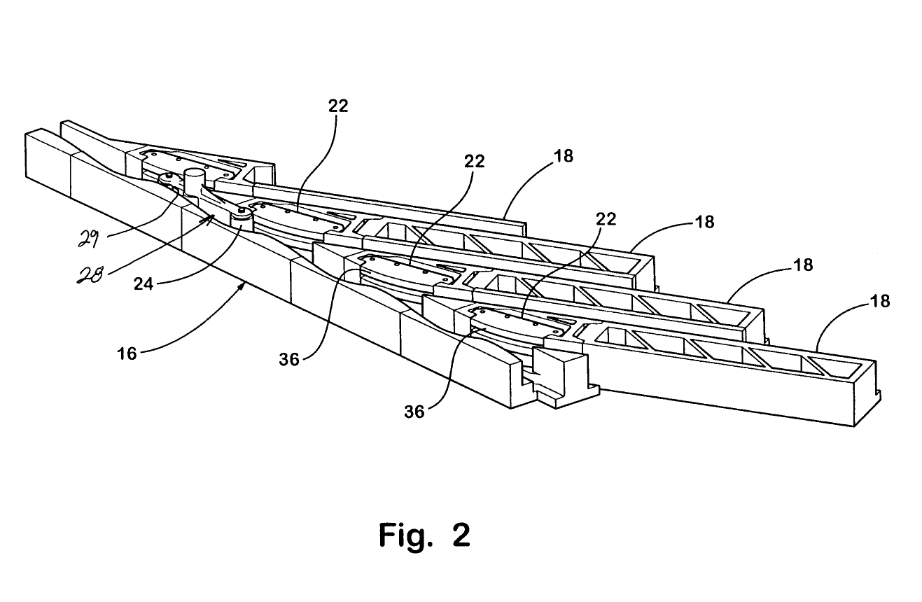

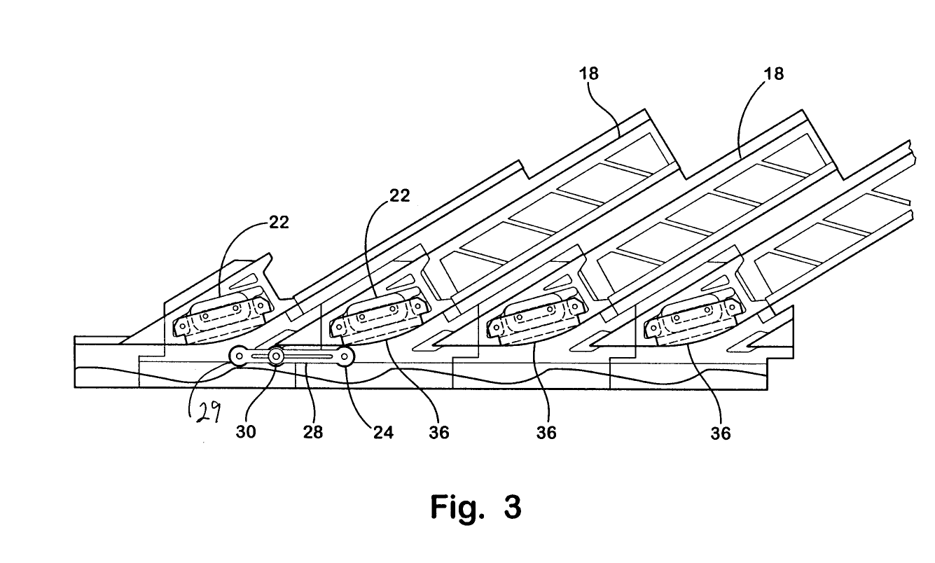

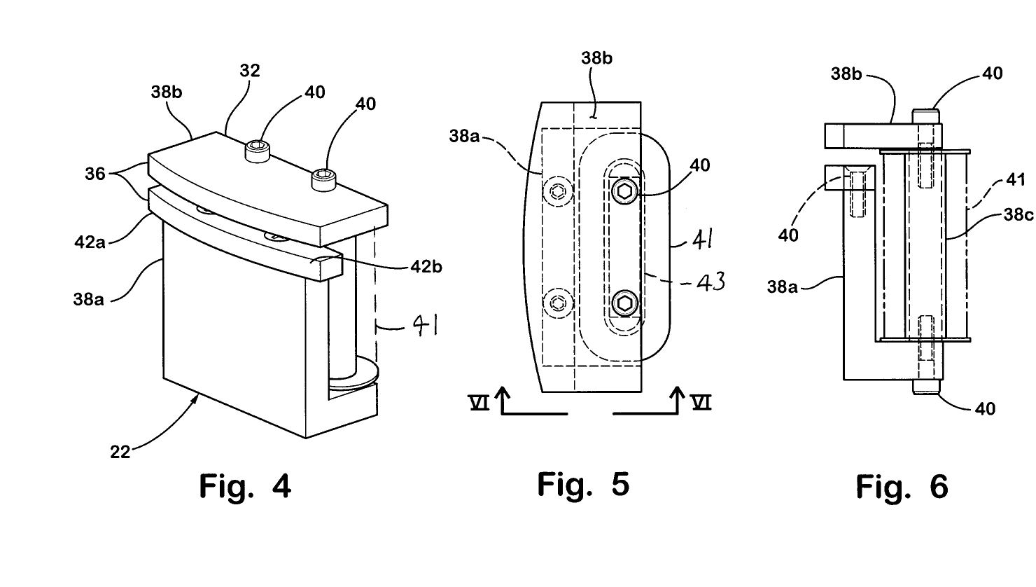

Referring now specifically to the drawings, and the illustrative embodiments depicted therein, a sorter assembly 10 is made up of a plurality of slats 20, which are interconnected in an endless web 12, an upper run of which defines a conveying surface 11. Pusher shoes, or diverter shoes, 26 traveling along some or all of the slats includes article contacting members 27 extending above the conveying surface to laterally displace articles on a conveying surface 11 (Fig. 1). Diverter assemblies 16 laterally displace pusher shoes 26 to divert articles onto selected spurs (not shown) in order to sort the articles (Figs. 2 and 3). To do this, diverter rails 18 (only a portion of the length of which is shown) extend diagonally across the conveying surface beneath the web and diverter assemblies 16 divert pusher shoes to diverter rails 33. Pusher shoes 26 include transfer assemblies 28 below conveying surface 11 to selectively engage a diverter rail 18 in order to laterally displace that pusher shoe.

Sorter assembly 10 may be of the parallel divert type as disclosed in commonly assigned United States Patent No. 5,165,515 and Published International Application No. WO 02/26602 published April 4, 2002; of the diagonal divert type as disclosed in commonly assigned United States Patent No. 5,127,510; or a combination of the parallel and diagonal divert type as disclosed in commonly assigned United States Patent Nos. 6,041,909 and 5,927,465, which are all hereby incorporated herein by reference.

Diverter assembly 16 includes one or more actuators 22 which electro-magnetically attract a magnetic member 24 of one or more pusher shoes 26 in order to direct the transfer assembly of that pusher shoe against a corresponding diverter rail 17. Magnetic member 24 is made from a material that is magnetically attracted to an electromagnet, such as a carbon steel member, or the like. Magnetic member 24 may be a bearing of the type disclosed in United States Patent No. 5,127,510 which also functions as the transfer assembly by the bearing engaging a diverter rail. Alternatively, magnetic member 24 may be a pilot member of the type disclosed in commonly assigned United States Patent application Serial No. 09/840,639 filed April2 001, by Veit et al. for a SORTATION SYSTEM DIVERTER SWITCH and Published International Application No. WO 01/83342 published November 8, 2001, the disclosures of which are hereby incorporated herein by reference. In the later embodiment, magnetic member 24 may be a roller supported by a transfer assembly in the form of a lever arm 28 which pivots about a pivot point 30 with respect to pusher shoe 26. The transfer assembly in such embodiment further includes a trailing low-friction member, such as another roller. In the illustrative embodiment, diverter assembly 16 is illustrated for use in a parallel, or partial parallel, diverter sorter assembly in which articles are, at least initially, diverted without substantial rotation of the articles. In such an application, corresponding portions of the actuators of a diverter assembly are spaced apart from each other by the shoe pitch of diverter shoes 26. The shoe pitch is the separation distance between corresponding portions of the pusher shoes in the direction of travel of conveying surface 11.

Actuator 22 may include a core 32 defining face portions 38. In the illustrative embodiment, core 32 is made up of core portions 38a, 38b joined together by fasteners 40 made of a non-magnetic material, such as a non-magnetic stainless steel. Fasteners 40 can be removed in order to insert a coil 41 to a plurality of core portions 38a, 38b and 38c. Coil 41 includes a series of turns of wire wound on a bobbin 43. Core portions 38a-38c are made from ferrous material. It should be understood that the invention may be utilized with actuators made from other core designs, such as from a unitary core or a core made from other than three core portions or having various shapes. Face 36 may be curved from a leading portion 42a to a trailing portion 42b in order to define a smooth transition onto a diverter rail 18.

Sorter assembly 10 may further include means for reducing residual magnetic attraction between actuator 22 and magnetic member 24. Among the many functions which such means may perform, the reducing of residual magnetic attraction between the actuator and the magnetic member is especially useful in allowing magnetic member 24 to be of relatively low mass and thereby attracted by relatively low actuating force. An example of a low mass magnetic pilot member is a magnetic member mounted by a lever arm. Because a relatively low magnetic force may attract magnetic member 24, stray magnetic fields, such as residual magnetism of actuator 22 may inadvertently divert the transfer assembly of a pusher shoe by an actuator 22 that is not energized as will be explained in more detail below.

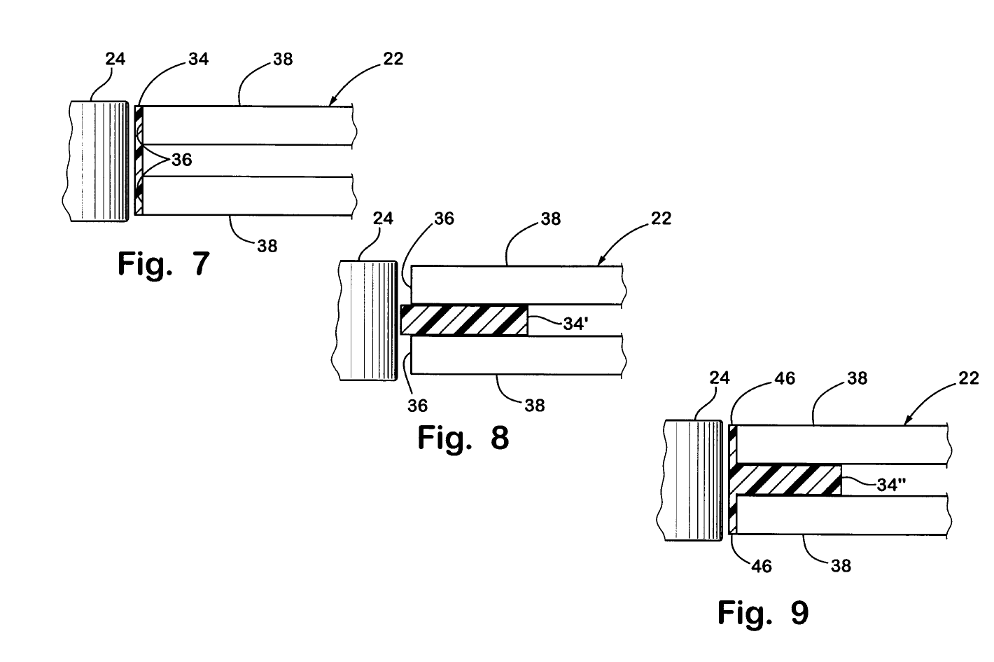

The means for reducing magnetic attraction between actuator 22 and magnetic member 24 may include structure of actuator 22 that spaces magnetic member 24 from a face 26 of actuator 22. Although other techniques may suggest themselves to the skilled artisan, such spacing may be accomplished by a spacer 34 extending beyond face 26 of actuator 22 in the direction of magnet member 24 (Fig. 7). Spacer 34 may be formed generally to the contour of face 36. Spacer 34 may have a uniform thickness from leading portion 42a to trailing portion 42b of face 36. Alternatively, spacer 34 may have a thickness which varies the magnetic separation between magnetic member 24 and face 36 that varies between leading portion 42a and trailing portion 42b. This may allow a stronger magnetic force to be applied at leading portion 42a in order to initially attract the magnetic member to the actuator and an increase in thickness towards trailing portion 42b where a lower attraction force is required. Alternatively, spacer 34 may have a greater thickness at leading portion 42a of face 36 in order to provide greater separation of the magnetic member from the actuator in order to avoid false actuation of the magnetic member when the actuator 22 is not be actuated.

Spacer 30 provides separation between magnetic member 24 and face 36 in order to reduce the affect of any residual magnetism in actuator 22 on magnetic member 24. This is because the level of magnetic attraction decreases with distance. It additionally provides the ability to have a wear strip which may be harder than the material defining face 36. This may enhance the durability of the diverter assembly. In the illustrative embodiment, face 34 is made from a non-magnetic material, such as 300 stainless steel, but may be a polymeric member or other non-magnetic material. The spacer may also be a replaceable member in order to increase the longevity of the diverter assembly.

In the embodiment illustrated in Fig. 7, spacer 34 is a strip which is placed over face 36. However, a spacer 34' may be in the form of an insert between core portion 38a, 38b which extends beyond face 36 in the direction of magnetic member 24 (Fig. 8). Alternatively, a spacer 34'' may b be in the form of an insert 44 which extends between core portions 38a, 38b and a strip portion 46 which extends from insert 44 over face 36 (Fig. 9). Other configurations for spacer 34 may be apparent to those of ordinary skill in the art, but are all to be included in the invention hereof.

In another embodiment, the spacing of magnetic member 24 from actuator 22 may be accomplished by laterally offsetting the face of actuator 22 a distance "d" from the longitudinal movement of magnetic member 24 (Fig. 15). Thus, as the magnetic member passes the actuator, the forward momentum of the magnetic member and the spacing of the magnetic member from the actuator force reduces the residual magnetic attraction between the actuator and the magnetic member, thus helping to reduce a false divert when the actuator is not energized. In order to assist in reducing residual magnetic attraction between the actuator and the magnetic member, a weak permanent magnet 57 may be positioned opposite actuator 22 which attracts another permanent magnet, or a magnetically permeable member on lever arm 28. The weak magnetic field generated by magnet 57 would readily be overcome with actuator 22' energized. Of course, magnet 57 could be an electro-magnet or could be replaced by a magnetically permeable member attracted by a permanent magnet on lever arm 28.

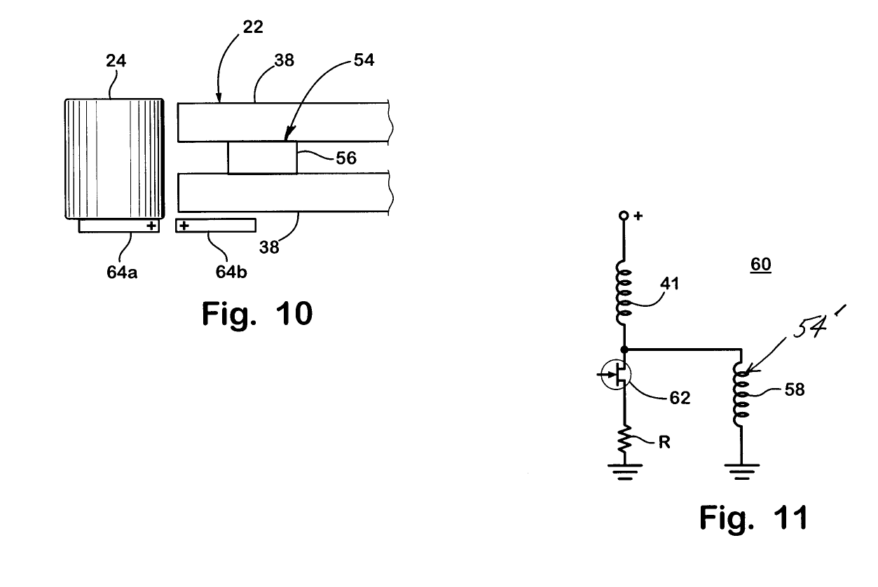

The means for reducing residual magnetic attraction between the actuator and the magnetic member may be in the form of reducing residual magnetism in the actuator. This may be accomplished by an auxiliary magnetic field generator 54, 54' for generating magnetic flux of opposite polarity to the flux generated by coil 41 (Figs. 10 and 11). The purpose of magnetic field generator 54,54' is in order to generate magnetic flux of generally equal magnitude but opposite polarity to that of residual flux in the actuator 22. Magnetic field generator 54 may be in the form of a permanent magnet 56 (Fig. 10). If a permanent magnet is utilized, the magnetic material must have a sufficiently high coercive force that the magnetic field established by coil 41, when energized, will not demagnetize the magnet 56. One material that may be utilized for permanent magnet 56 is samarium cobalt. Other permanent magnet materials are known, such as ceramic-barium-ferrite, or the like. Other materials may suggest themselves to those skilled in the art. By substantially nullifying the residual magnetic field, direct contact between magnetic member 24 and face 36 can be accommodated while reducing false diverts.

Alternatively, a magnetic field generator 54' may be in the form of an electromagnet defined by an auxiliary coil 58. Coil 58 is wound in a manner that produces a magnetic flux that is opposite to that produced by coil 41. Coil 58 may be wound separately from, but concentric with, coil 41. Coil 58 may be in the form of a wire having a smaller diameter than that defining coil 41. The coil 58 may be driven with a constant current source. This would tend to eliminate temperature dependence of the coil 58, particularly if it is energized substantially all or most of the time. Coil 58 may additionally be wound over coil 41 and may be energized in a manner illustrated in Fig. 11. Fig. 11 illustrates a circuit 60 for actuator 22 in which an actuating switch 62 selectively actuates coil 41 in order to divert a pusher shoe 26. Coil 58 is energized through a current that passes through coil 41 when switch 62 is deactivated. A resistor R may be used in a feedback circuit to keep current constant during activation of switch 62.

Means for reducing residual magnetic attraction between the actuator and magnetic member may include at least two opposing magnets 64a, 64b (Fig. 10). One of the magnets 64a, 64b is mounted to pusher shoe 26, such as at the magnetic member 24 thereof. The other of magnets 64a, 64b is mounted at one of the diverter assemblies 16, such as at actuator 22. The magnets 64a, 64b are adapted to repel each other in order to overcome residual magnetism of the actuator when the actuator is not actuating one of the pusher shoes. Magnets 64a, 64b may be adapted to repel each other by having a like pole facing each other, such as positive-pole-facing-positive-pole, or negative-pole-facing-negative-pole, or the like. Preferably, magnets 64a, 64b are permanent magnets although magnet 64b could be an electromagnet.

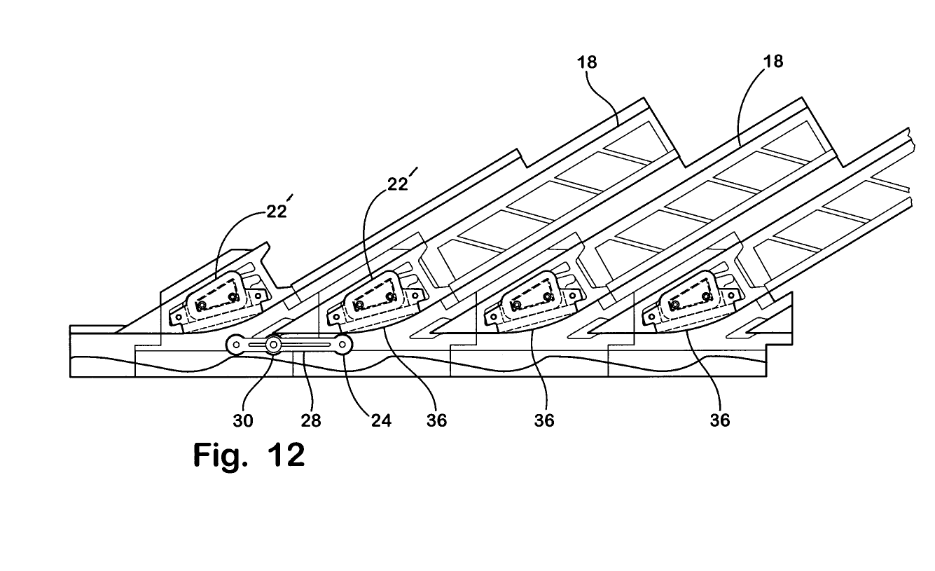

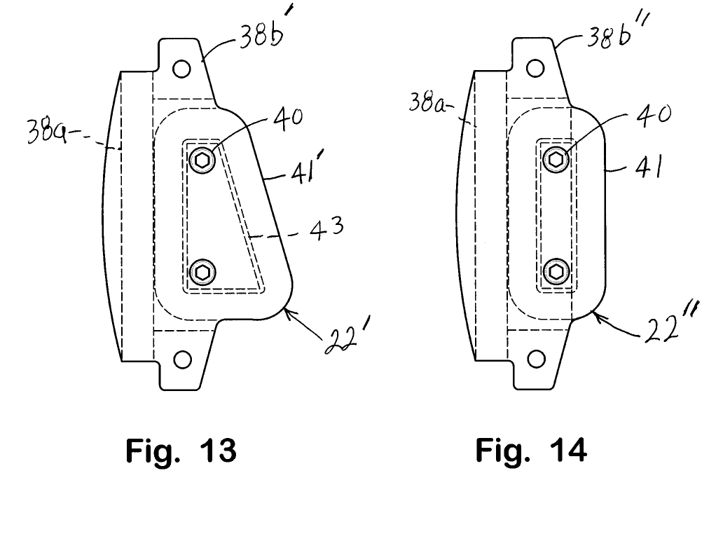

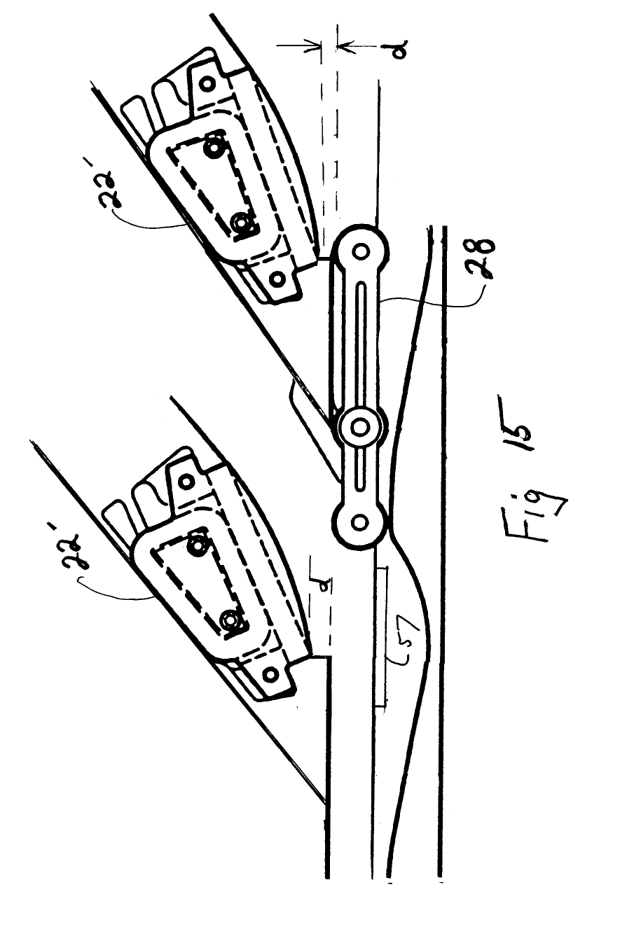

In an alternative embodiment, an actuator 22' includes a coil 41 having an asymmetric winding position on an asymmetric core (Figs. 12 and 13). The advantage of actuator 22' is that coil 41' is wound around an asymmetric bobbin 43. Asymmetric bobbin 43 produces a coil 41' which fits within the combined space of the diverter assembly, as is best illustrated in Fig. 12. Additionally, the configuration of bobbin 43' provides additional strength which allows a higher magnetic attractive force to be generated by coil 41'. An alternative actuator 22'' is similar to actuator 22, except that a core portion 38b'' substantially entirely overlays the coil 41. The lower portion of core portion 38a'' may also completely underlay coil 41.

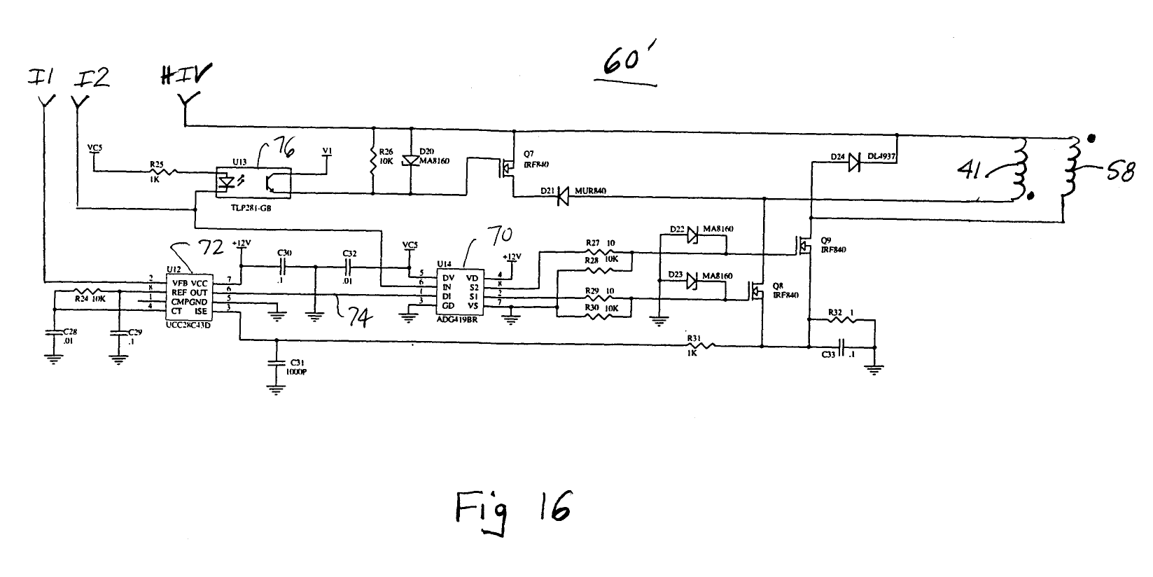

An alternative electronic circuit 60' may be used for supplying actuator current to primary actuating coil 41 and to auxiliary coil 58 (Fig. 16). Circuit 16' actuates primary coil 41 for a predetermined period of time in order to attract magnetic member 24. After primary coil 41 is deactuated, auxiliary coil 58 is actuated for a predetermined period of time and then deactuated. Fig. 16 illustrates a circuit for actuating the coils associated with one actuator 22. It should be understood that a similar circuit would be provided for each actuator 22.

Circuit 60' receives three inputs labeled I1, I2 and HIV. HIV is a power supply line capable of supplying sufficient current to actuate coils 41 and 58. It may be supplied from a DC power supply of the type that is well known in the art. Inputs I1 and I2 may be supplied from a computer-based control, such as a divert control module of the type disclosed in commonly assigned United States patent application Serial No. 10/163,788, filed June 6, 2002, by David W. Zeiter et al. entitled TIERED CONTROL ARCHITECTURE FOR MATERIAL HANDLING, the disclosure of which is incorporated herein by reference. Input I2 is supplied to an analog switch 70 having outputs capable of switching electronic switches Q8 and Q9, which, in the illustrative embodiment, are field-effect transistors (FET). Analog switch 70 is of the type well known in the art. Each FET is supplied to one terminal of respective coils 41, 58, the opposite terminals of which are supplied to voltage supply HIV. In circuit 60', coils 41 and 58 are configured to be operated in opposite magnetic polarity as represented by the dots on the schematic adjacent the respective coils. Input I1 is supplied to a current controller 72 having an output 74 which is supplied as an input to analog switch 70. Current controller 72 receives a signal derived from a current-sensing resistor R32 which senses the current supplied to respective coils 41 and 58. In this manner, the coils may be driven at a controlled current, such as a constant current. In the illustrative embodiment, current controller 72 is a pulse-width-modulated (PWM) circuit of the type known in the art.

In operation, inputs I1 and I2 are driven to a polarity opposite the polarity of voltage source HIV in order to divert one or more pusher shoes. In the illustrative embodiment, voltage source HIV is a positive DC voltage and each input I1 and I2 are 5 volt TTL level control lines that are driven low in order to initiate a divert. With inputs I1 and I2 driven low, analog switch 70 causes electronic switch Q8 to conduct in order to energize primary coil 41. Input I2 also is supplied through an opto-coupler 76 to an electronic switch Q7 which places a dampening diode D21 in parallel with coil 41. In this manner, when switch Q8 is opened, the collapsing of the field at coil 41 is dissipated through diode D21. At the end of a predetermined period, input I2 is allowed to go to a high state, which causes analog switch 70 to open switch Q8 and close switch Q9. This causes primary coil 41 to cease being energized and auxiliary coil 58 to become energized. The energization of coil 58 is at a level sufficient to substantially reverse residual magnetism in the respective actuator. After a predetermined period of time, input I1 is allowed to return to a high state which causes analog switch 70 to open switch Q9 which de-energizes auxiliary coil 58. Thus, it is seen that circuit 60' energizes primary coil 41 for a predetermined period of time and, immediately subsequent to de-energizing coil 41, energizes the auxiliary coil for another predetermined period of time. In the illustrative embodiment, auxiliary coil 58 is actuated by circuit 60' for 20 milliseconds after primary coil 41 is turned off. In the illustrative embodiment, this produces 20 gauss to remove the residual magnetism produced by the primary coil while the primary coil is energized.

Thus, it is said that the present invention provides a means for overcoming the difficulty associated with actuating a very low mass magnetic member associated with a pusher shoe in a sortation system. This is accomplished by reducing residual magnetic attraction between the actuator and the magnetic member when the actuator is not being energized, thereby avoiding mis-diverts and non-diverts. While many examples are provided herein of means to accomplished such reduction, it should be understood that such examples are not exclusive and are merely illustrative. Other examples may become apparent to one of ordinary skill in the art, once the skilled artisan is motivated to provide such means by the disclosure presented herein. Furthermore, although multiple different devices are disclosed herein in order to provide such means for controlling an amount of actuation force applied to the magnetic member, it should be understood that they may be applied either individually or in combination.

Changes and modifications in the specifically described embodiments can be carried out without departing from the principles of the invention which is intended to be limited only by the scope of the appended claims, as interpreted according to the principles of patent law including the doctrine of equivalents.

Claims

1. A method of sorting objects, comprising:
providing a sorter having a conveying surface, a plurality of pusher shoes capable of traveling laterally of said conveying surface, a plurality of diverting rails extending diagonally under said conveying surface and a plurality of diverters associated with said diverting rails;
wherein said pusher shoes includes an article-contacting member extending at least partially above said conveying surface to laterally displace articles on said conveying surface and a transfer assembly having a magnetic member below said conveying surface, said transfer assembly engaging one of said diverting rails to laterally displace the corresponding one of said pusher shoes;
providing actuators at said diverters and selectively energizing said actuators to attract at least one of said magnetic members toward the associated one of said diverting rails; and
reducing residual magnetic attraction between said actuators and said magnetic members when said actuators are not being energized.

2. The method of sorting of claim 1 wherein said reducing residual magnetic attraction includes reducing residual magnetism at the actuators.

3. The method of sorting of claim 2 wherein said actuators include a primary magnetic coil and including producing with said primary magnetic coil a magnetic flux having a particular polarity in order to attract at least one of said magnetic members.

4. The method of sorting of claim 3 wherein said reducing residual magnetism includes providing an auxiliary magnetic coil and producing with said auxiliary magnetic coil another magnetic flux having a polarity that is opposite to said particular polarity.

5. The method of sorting of claim 4 including applying an electric current to said primary magnetic coil thereby producing said magnetic flux to attract at least one of said magnetic members and applying another electric current to said auxiliary magnetic coil thereby producing said another magnetic flux.

6. The method of sorting of claim 5 including applying said another electric current after said applying said electric current.

7. The method of sorting of claim 3 wherein said reducing residual magnetism includes providing a permanent magnet and producing with said permanent magnet another magnetic flux having a polarity that is opposite to said particular polarity.

8. The method of sorting of claim 1 wherein said reducing residual magnetic attraction includes spacing said magnetic members from said actuators.

9. The method of sorting of claim 8 wherein said spacing includes providing spacers and positioning said spacers between said magnetic members and said actuators.

10. The method of sorting of claim 9 including positioning said spacers at a face of said actuators that attracts said magnetic members.

11. The method of sorting of claim 8 wherein said spacing includes configuring a face of said actuators that attracts said magnetic members to be laterally offset from a path of longitudinal movement of said magnetic members.

12. The method of sorting of claim 1 wherein said reducing residual magnetic attraction includes providing permanent magnets at said magnetic members and repelling said permanent magnets with said actuators when said actuators are not attracting said magnetic members.

13. The method of sorting of claim 12 wherein said repelling said permanent magnets includes providing other permanent magnets at said actuators having poles arranged to repel said permanent magnets.

14. The method of sorting of claim 1 wherein said transfer assembly comprises a lever arm including a pilot member made of a magnetically permeable material.

15. The method of sorting of claim 14 wherein said pilot member comprises a roller.

16. The method of sorting of claim 14 wherein said transfer assembly further includes a trailing low-friction member.

17. The method of sorting of claim 1 wherein said conveying surface is defined by an upper run of a plurality of slats that are interconnected in an endless web and wherein said pusher shoes travel along at least some of said plurality of slats to laterally displace articles on said conveying surface.

18. The method of sorting of claim 1 wherein corresponding portions of said pusher shoes are being generally separated from each other in said travel direction by a shoe pitch and wherein corresponding portions of at least two of said actuators are being substantially separated from each other by no more than said shoe pitch, thereby providing at least partial parallel sorting.

19. A method of sorting objects, comprising:
providing a sorter having a conveying surface, a plurality of pusher shoes capable of traveling laterally of said conveying surface, a plurality of diverting rails extending diagonally under said conveying surface and a plurality of diverters associated with said diverting rails;
wherein said pusher shoes include an article-contacting member extending at least partially above said conveying surface to laterally displace articles on said conveying surface and a transfer assembly having a magnetic member below said conveying surface, said transfer assembly engaging one of said diverting rails to laterally displace the corresponding one of said pusher shoes;
providing actuators at said diverters, said actuators including a primary magnetic coil and an auxiliary magnet;
selectively energizing said primary magnetic coil to attract at least one of said magnetic members toward the associated one of said diverting rails including producing a primary magnetic flux having a particular polarity; and
producing an auxiliary magnetic flux with said auxiliary magnet having a polarity that is opposite said particular polarity thereby reducing residual magnetism when said primary magnetic coil is not energized.

20. The method of sorting of claim 19 wherein said auxiliary magnet comprises an auxiliary magnetic coil, and further including selectively energizing said auxiliary magnetic coil to produce said auxiliary magnetic flux.

21. The method of sorting of claim 20 including energizing said auxiliary magnetic coil when said primary magnetic coil is not being energized.

22. The method of sorting of claim 21 including energizing said auxiliary magnetic coil for a period of time after said primary magnetic coil ceases to be energized.

23. The method of sorting of claim 20 including applying an electric current to said primary magnetic coil thereby producing said primary magnetic flux to attract at least one of said magnetic members and applying another electric current to said auxiliary magnetic coil thereby producing said auxiliary magnetic flux.

24. The method of sorting of claim 23 including applying said another electric current after said applying said electric current.

25. The method of sorting of claim 19 wherein said auxiliary magnet comprises a permanent magnet.

26. The method of sorting of claim 19 wherein said transfer assembly comprises a lever arm including a pilot member made of a magnetically permeable material.

27. The method of sorting of claim 26 wherein said pilot member comprises a roller.

28. The method of sorting of claim 26 wherein said transfer assembly further includes a trailing low-friction member.

29. The method of sorting of claim 19 wherein said conveying surface is defined by an upper run of a plurality of slats that are interconnected in an endless web and wherein said pusher shoes travel along at least some of said plurality of slats to laterally displace articles on said conveying surface.

30. The method of sorting of claim 19 wherein corresponding portions of said pusher shoes are being generally separated from each other in said travel direction by a shoe pitch and wherein corresponding portions of at least two of said actuators are being substantially separated from each other by no more than said shoe pitch, thereby providing at least partial parallel sorting.

31. A sorter apparatus, comprising:
a conveying surface;
a plurality of pusher shoes capable of traveling laterally of said conveying surface,
a plurality of diverting rails extending diagonally under said conveying surface; and
a plurality of diverters associated with said diverting rails for selectively diverting said pusher shoes to the associated diverters;
wherein said pusher shoes include an article-contacting member extending at least partially above said conveying surface to laterally displace articles on said conveying surface and a transfer assembly having a magnetic member below said conveying surface, said transfer assembly engaging one of said diverting rails to laterally displace the corresponding one of said pusher shoes;
wherein said diverters include actuators for selectively actuating at least one of said magnetic members toward the associated one of said diverting rails; and
means for reducing residual magnetic attraction between said actuators and said magnetic members when said actuators are not being energized.

32. The sorter apparatus of claim 31 wherein said means for reducing residual magnetic attraction includes means for reducing residual magnetism at the actuators.

33. The sorter apparatus of claim 32 wherein said actuators include a primary magnetic coil, said primary magnetic coil producing when energized a magnetic flux having a particular polarity in order to attract at least one of said magnetic members.

34. The sorter apparatus of claim 33 wherein said means for reducing residual magnetism includes an auxiliary magnetic coil, said auxiliary magnetic coil producing when energized another magnetic flux having a polarity that is opposite to said particular polarity.

35. The sorter apparatus of claim 34 including a control that applies an electric current to said primary magnetic coil thereby producing said magnetic flux to attract at least one of said magnetic members and applies another electric current to said auxiliary magnetic coil thereby producing said another magnetic flux.

36. The sorter apparatus of claim 35 wherein said control applies said another electric current after applying said electric current.

37. The sorter apparatus of claim 33 wherein said means for reducing residual magnetism includes a permanent magnet that produces another magnetic flux having a polarity that is opposite to said particular polarity.

38. The sorter apparatus of claim 31 wherein said means for reducing residual magnetic attraction includes means for spacing said magnetic members from said actuators.

39. The sorter apparatus of claim 38 wherein said means for spacing includes spacers positioned between said magnetic members and said actuators.

40. The sorter apparatus of claim 39 wherein said spacers are positioned at a face of said actuators that attracts said magnetic members.

41. The sorter apparatus of claim 38 wherein said means for spacing includes a face of said actuators that attracts said magnetic members to being laterally offset from a path of longitudinal movement of said magnetic members.

42. The sorter apparatus of claim 31 wherein said means for reducing residual magnetic attraction includes permanent magnets at said magnetic members, said permanent magnets being repelled with said actuators when said actuators are not attracting said magnetic members.

43. The sorter apparatus of claim 42 including other permanent magnets at said actuators having poles arranged to repel said permanent magnets.

44. The sorter apparatus of claim 31 wherein said transfer assembly comprises a lever arm including a pilot member made of a magnetically permeable material.

45. The sorter apparatus of claim 44 wherein said pilot member comprises a roller.

46. The sorter apparatus of claim 44 wherein said transfer assembly further includes a trailing low-friction member.

47. The sorter apparatus of claim 31 wherein said conveying surface is defined by an upper run of a plurality of slats that are interconnected in an endless web and wherein said pusher shoes travel along at least some of said plurality of slats to laterally displace articles on said conveying surface.

48. The sorter apparatus of claim 31 wherein corresponding portions of said pusher shoes are being generally separated from each other in said travel direction by a shoe pitch and wherein corresponding portions of at least two of said actuators are being substantially separated from each other by no more than said shoe pitch, thereby providing at least partial parallel sorting.

49. A sorter apparatus, comprising:
a conveying surface;
a plurality of pusher shoes capable of traveling laterally of said conveying surface;
a plurality of diverting rails extending diagonally under said conveying surface; and
a plurality of diverters associated with said diverting rails for selectively diverting said pusher shoes to the associated diverters;
wherein said pusher shoes include an article-contacting member extending at least partially above said conveying surface to laterally displace articles on said conveying surface and a transfer assembly having a magnetic member below said conveying surface, said transfer assembly engaging one of said diverting rails to laterally displace the corresponding one of said pusher shoes;
wherein said diverters include actuators for selectively actuating at least one of said magnetic members toward the associated one of said diverting rails, said actuators including a primary magnetic coil and an auxiliary magnet;
said primary magnetic coil attracting at least one of said magnetic members toward the associated one of said diverting rails including producing a primary magnetic flux having a particular polarity; and
said auxiliary magnet producing an auxiliary magnetic flux having a polarity that is opposite said particular polarity thereby reducing residual magnetism when said primary magnetic coil is not energized.

50. The sorter apparatus of claim 49 wherein said auxiliary magnet comprises an auxiliary magnetic coil, wherein said auxiliary magnetic coil produces said auxiliary magnetic flux when energized.

51. The sorter apparatus of claim 50 wherein said auxiliary magnetic coil is energized when said primary magnetic coil is not being energized.

52. The sorter apparatus of claim 51 wherein said auxiliary magnetic coil is energized for a period of time after said primary magnetic coil ceases to be energized.

53. The sorter apparatus of claim 50 including a control, said control applying an electric current to said primary magnetic coil thereby producing said primary magnetic flux to attract at least one of said magnetic members and applying another electric current to said auxiliary magnetic coil thereby producing said auxiliary magnetic flux.

54. The sorter apparatus of claim 53 wherein said control applies said another electric current after said applying said electric current.

55. The sorter apparatus of claim 49 wherein said auxiliary magnet comprises a permanent magnet.

56. The sorter apparatus of claim 49 wherein said transfer assembly comprises a lever arm assembly including a pilot member made of a magnetically permeable material.

57. The sorter apparatus of claim 56 wherein said pilot member comprises a roller.

58. The sorter apparatus of claim 56 wherein said magnetic members further include a trailing low-friction member.

59. The sorter apparatus of claim 49 wherein said conveying surface is defined by an upper run of a plurality of slats that are interconnected in an endless web and wherein said pusher shoes travel along at least some of said plurality of slats to laterally displace articles on said conveying surface.

60. The sorter apparatus of claim 49 wherein corresponding portions of said pusher shoes are being generally separated from each other in said travel direction by a shoe pitch and wherein corresponding portions of at least two of said actuators are being substantially separated from each other by no more than said shoe pitch, thereby providing at least partial parallel sorting.
